(19) United States
(12) Patent Application Publication
(10) Pub. No.: US 2012/0293890 A1
(43) Pub. Date: Nov. 22, 2012

(54) SYSTEM, METHOD AND APPARATUS FOR ENHANCING AIR FLOW CIRCULATION IN DISK DRIVES

(76) Inventors: Charles Allan Brown, San Jose, CA (US); Ferdinand Hendriks, Morgan Hill, CA (US)

(21) Appl. No.: 13/109,827

(22) Filed: May 17, 2011

(51) Int. Cl. G11B 33/14

(52) U.S. Cl. 360/97.14; G9B/33.035

(57) ABSTRACT

A disk drive disk has a disk rim and a shroud faces the disk rim. At least one of the disk rim and the shroud interior surface have features formed thereon that cause both axial and circumferential air flow when the disk is rotated relative to the shroud, and the features extend for an axial distance of no more than the axial thickness of the disk. The features may extend both axially and circumferentially relative to said at least one of the disk rim and the shroud interior surface. The features may be slanted or helical slits. The disk rim also may be asymmetric, such as asymmetrically beveled.

### BACKGROUND OF THE INVENTION

1. Field of the Disclosure

The present invention relates in general to storage media and, in particular, to a system, method and apparatus for enhancing air flow circulation in disk drives.

2. Description of the Related Art

Disk drives such as magnetic or optical disk drives, read data from and write data to media disks. For example, hard disk drives having magnetic patterns on magnetic media have been used for decades to store digital data, and offer low cost, high recording capacity, and rapid data retrieval.

Particles inside disk drives are generally undesirable, particularly when they reside on the disk's recording surfaces accessed by the read/write head. Once particles are on the surface it is impossible to remove them by aerodynamic forces. Despite meticulous cleaning, some airborne particles are present particularly during the first moments of the operational life of a hard disk drive. Particles generally migrate to moving and stationary walls by turbulent and Brownian diffusion. The hard drive's particle filter is especially equipped to remove particles by electrostatic (electret filter media) means. In addition, a significant fraction of particles lands on stationary surfaces such as the base casting. Once on the surface, particles are tightly held by van der Waals forces which are much stronger than forces of aerodynamic origin. Thus, particle removal is typically performed with the air flow created by the spinning disk pack in combination with an air filtration system.

Some known solutions produce insufficient air flow. Filter placement for maximum flow rate is problematic for other applications due to restrictions imposed by existing components. Disk drive cleaning is especially problematic for depopulated disk drives that have fewer disks than their maximum capacity. Moreover, pumping air by viscosity between the disk and air is extremely inefficient, especially at high Reynolds numbers. Thus, improvements in cleaning disk drives continue to be of interest.

### SUMMARY

Embodiments of a system, method and apparatus for enhancing air flow circulation in disk drives are disclosed. In some embodiments, a disk drive comprises an enclosure; a disk rotatably mounted to the enclosure and having an axis, an axial thickness and a disk rim at a disk outer perimeter thereof; an actuator pivotally mounted to the enclosure for reading data from the disk; a shroud mounted to the enclosure adjacent the disk and having a shroud interior surface facing the disk rim; and at least one of the disk rim and the shroud interior surface have features formed thereon that cause both axial and circumferential air flow when the disk is rotated relative to the shroud, and the features extend for an axial distance of no more than the axial thickness of the disk.

The features may extend both axially and circumferentially relative to said at least one of the disk rim and the shroud interior surface. The features may be slanted or helical. The helical features may have an axial periodicity of about 100 mm. The features may comprise slits that extend into said at least one of the disk rim and shroud interior surface. The slits may have a radial dimension of about 0.15 to 0.3 mm. The disk rim may be beveled at about 45 degrees with bevels having a radial dimension of about 0.150 mm. The features may be formed at a circumferential pitch angle of about 2 to 10 degrees relative to said at least one of the disk rim and shroud interior surface. The features may extend continuously and completely around the disk rim or shroud interior surface.

In still other embodiments, the disk rim is asymmetric, such as asymmetrically beveled. For example, the disk rim may be asymmetrically beveled with chamfers having a radial dimension of about 0.1 mm on one axial side of the disk rim, and about 0.25 mm on an opposite axial side of the disk rim.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic top view of an embodiment of a disk drive;

FIG. 2 is an isometric view of an embodiment of a disk;

FIG. 3 is a side view of an embodiment of the disk of FIG. 2;

FIG. 4 is a schematic top view of an embodiment of the disk adjacent a shroud;

FIG. 5 is a side view of an embodiment of the disk and shroud of FIG. 4;

FIG. 6 is a schematic isometric view of an embodiment of a disk;

FIG. 7 is a schematic isometric view of an embodiment of a shroud;

FIG. 8 is a schematic side sectional view of another embodiment of a disk rim of a disk;

FIG. 9 is a schematic side sectional view of an embodiment of a set of disks in a disk drive; and

FIG. 10 is a schematic side sectional view of yet another embodiment of a disk rim of a disk.

The use of the same reference symbols in different drawings indicates similar or identical items.

### DETAILED DESCRIPTION

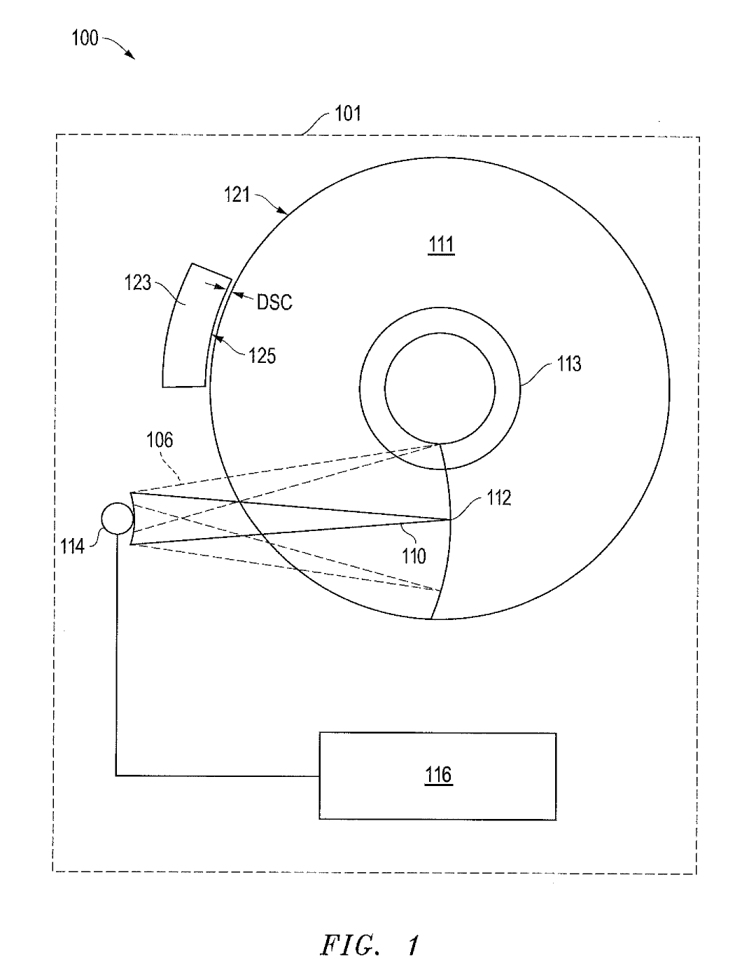

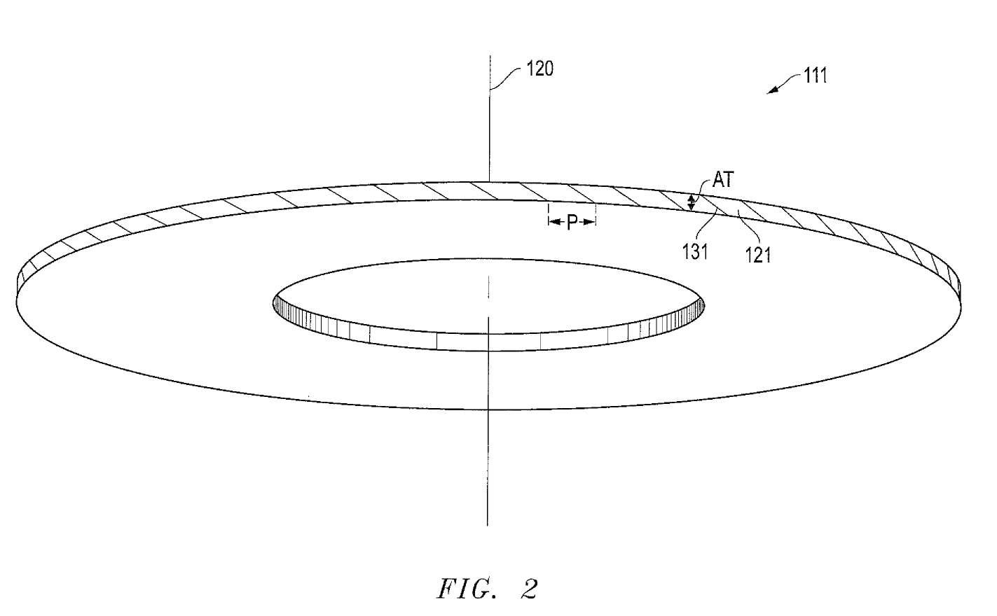

Embodiments of a system, method and apparatus for enhancing air flow circulation in disk drives are disclosed. For example, FIG. 1 discloses an embodiment of a disk drive 100 comprising an enclosure 101 and a disk 111 rotatably mounted to the enclosure 101. The disk 111 has an axis 120 (FIG. 2), and an axial thickness AT of about 0.625 mm in some embodiments. The disk 111 also has a disk rim 121 at a disk outer perimeter thereof. An actuator 106 is pivotally mounted to the enclosure 101 for reading data from and/or writing data to the disk 111. A shroud 123 is mounted to the enclosure 101 adjacent the disk 111. The shroud 123 has an innermost shroud interior surface 125 that faces the disk rim 121. A disk to shroud clearance DSC (FIGS. 1, 4 and 5) is defined between disk rim 121 and shroud interior surface 125, and is about 0.160 mm in some embodiments. The DSC is the minimum spacing between the disk and shroud.

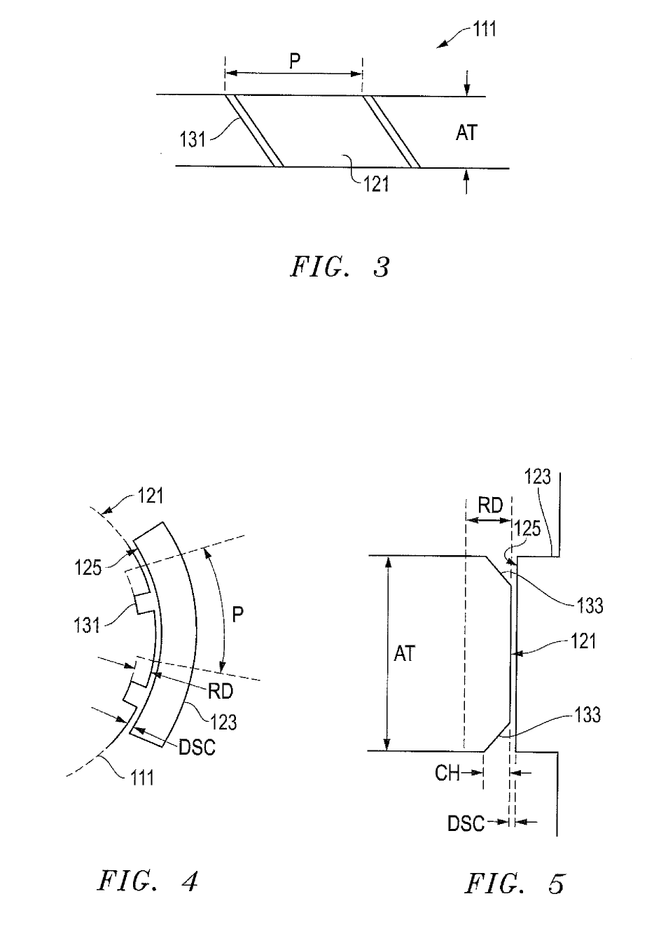

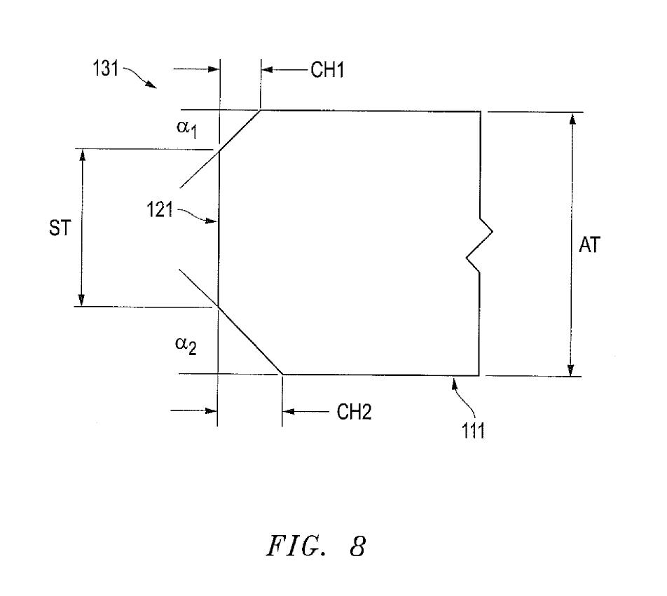

In some embodiments, at least one of the disk rim 121 (FIGS. 2-6) and the shroud interior surface 125 (FIG. 7) have features 131 formed thereon that cause both axial and circumferential air flow in the disk drive when the disk 111 is rotated relative to the shroud 123. Embodiments of the features 131 may extend for an axial distance of no more than the axial thickness AT of the disk 111. Because of the close proximity provided by the disk to shroud clearance DSC, there is an axial air flow generated at the disk rim 121 facing the disk shroud inner surface 125 to achieve additional air flow mixing. In some embodiments, there are equal and axially opposite air flows elsewhere, such as near the actuator 106.

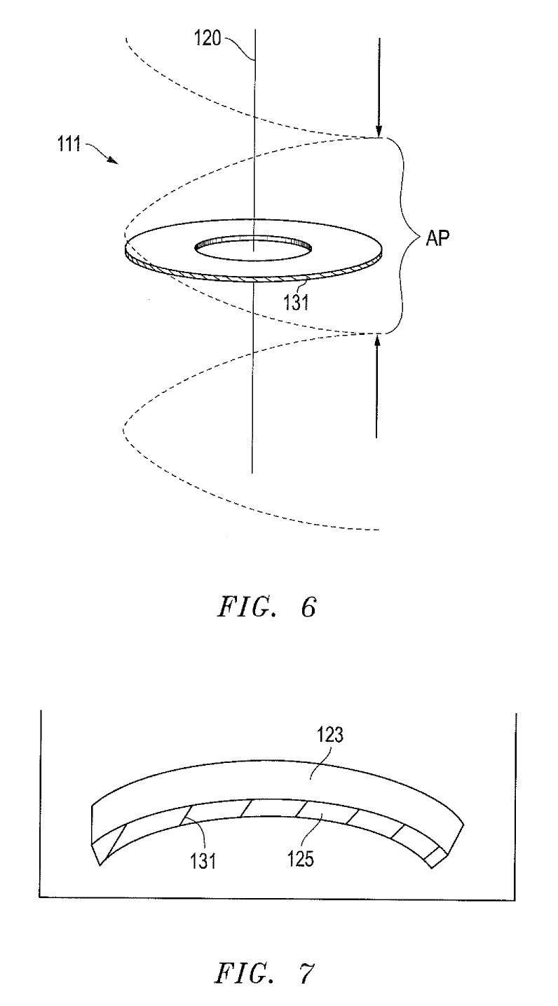

For example, the features 131 may extend both axially and circumferentially relative to said at least one of the disk rim 121 and shroud interior surface 125, in some embodiments. The features 131 may be slanted or helical as shown. As depicted in FIG. 6, the helical features 131 may have an axial periodicity AP of about 100 mm in the axial direction. All disks have chamfered edges to avoid disk edge chipping.

The features 131 may comprise slits that may be milled, ground or etched as slanted grooves that extend into said at least one of the disk rim 121 and shroud interior surface 125. For example, the features may have a radial dimension RD (FIGS. 4 and 5) of about 0.15 to 0.3 mm. The disk rim 121 may be beveled or chamfered at about 45 degrees with bevels 133 having a radial dimension CH of about 0.150 mm.

In some embodiments, the features 131 may be formed at a circumferential pitch angle P (FIGS. 2-4) of about 2 to 10 degrees relative to said at least one of the disk rim 121 and shroud interior surface 125. To address acoustic noise issues, it may be advantageous to select the passage frequency of the features or grooves (relative to a stationary location) to be beyond the human hearing capacity of 20 kHz. For example, providing a disk with grooves formed in the disk rim every 2 degrees provides the disk rim with 180 grooves. When the disk is rotated at 10,000 rpm or 167 rps, the groove passing frequency is 167×180=30,060 Hz. In some embodiments, the features 131 extend continuously and completely around the disk rim 121 or on shroud interior surface 125.

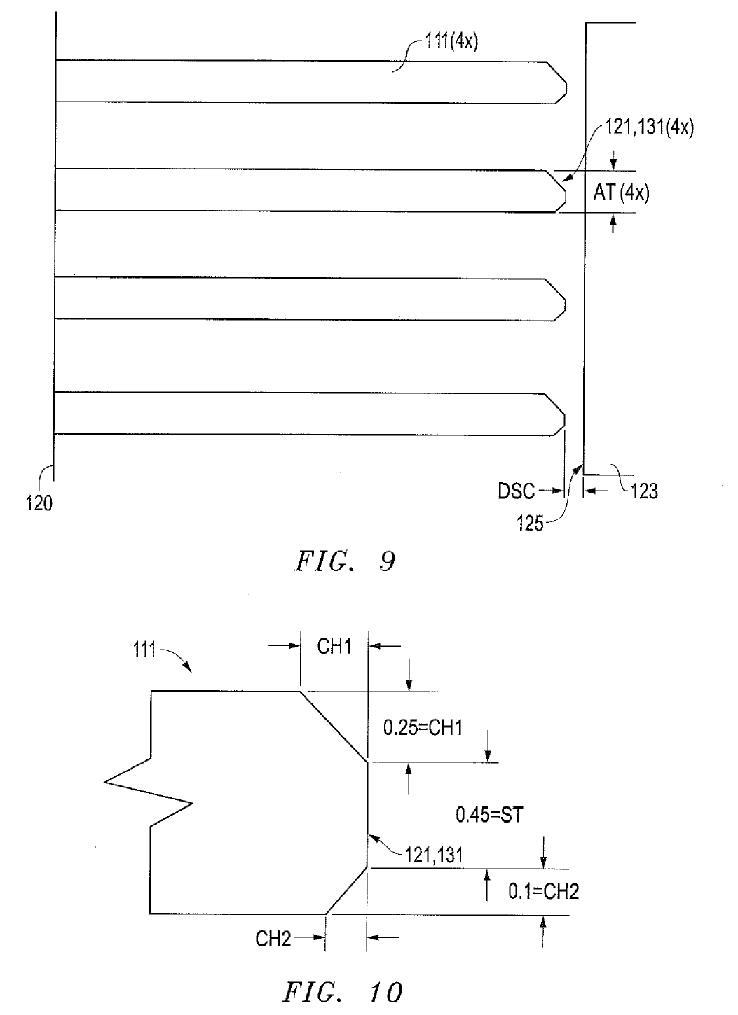

Referring now to FIGS. 8-10, the disk feature 131 of disk 111 may comprise an intentional asymmetry formed at the disk rim 121, such as unequal top and bottom disk bevels or chamfers CH1, CH2. These features may be used independently of or in conjunction with the slits described herein. The chamfers CH1, CH2 may be formed at the same angle, or at different angles α₁, α₂. The disk rim 121 has a “straight” axial thickness ST of about 0.4 to 0.6 mm.

For example, the chamfers may both be formed at 45 degrees, with a top chamfer of about 0.2 to 0.3 mm and a bottom chamfer of about 0.1 mm. In one embodiment, the radial and axial dimensions of the top chamfer on one axial side of the disk rim are 0.25 mm, and the radial and axial dimensions of the chamfer CH2 (e.g., the bottom) on the other or opposite axial side of disk rim is about 0.1 mm. In some embodiments, the chamfer asymmetry is oriented in the same direction for each disk, such as a large top chamfer and a small bottom chamfer. However, these embodiments also are applicable to depopulated disk drives. In still other embodiments, these asymmetrical chamfers may be formed on one or both of the disk edge and the shroud.

In some embodiments, a disk drive comprises an enclosure; a disk rotatably mounted to the enclosure and having an axis, an axial thickness and a disk rim at a disk outer perimeter thereof; an actuator pivotally mounted to the enclosure for reading data from the disk; a shroud mounted to the enclosure adjacent the disk and having a shroud interior surface facing the disk rim; and at least one of the disk rim and the shroud interior surface have features formed thereon that cause both axial and circumferential air flow when the disk is rotated relative to the shroud, and the features extend for an axial distance of no more than the axial thickness of the disk.

The features may extend both axially and circumferentially relative to said at least one of the disk rim and the shroud interior surface. The features may be slanted or helical. The helical features may have an axial periodicity of about 100 mm. The features may comprise slits that extend into said at least one of the disk rim and shroud interior surface. The slits may have a radial dimension of about 0.15 to 0.3 mm. The disk rim may be beveled at about 45 degrees with bevels having a radial dimension of about 0.150 mm. The features may be formed at a circumferential pitch angle of about 2 to 10 degrees relative to said at least one of the disk rim and shroud interior surface. The features may extend continuously and completely around the disk rim or shroud interior surface.

In still other embodiments, the disk rim is asymmetric, such as asymmetrically beveled. The disk rim may be asymmetrically beveled with chamfers having a radial dimension of about 0.1 mm on one axial side of the disk rim, and about 0.25 mm on an opposite axial side of the disk rim.

Again referring to FIG. 1, the hard disk drive assembly 100 generally comprises the housing or enclosure 101 with one or more disks 111 as described herein. The disk 111 comprises magnetic recording media rotated at high speeds by a spindle motor (not shown) during operation adjacent the disk shroud 123. The concentric data tracks 113 are formed on either or both disk surfaces magnetically to receive and store information.

Embodiments of a read or read/write head 110 may be moved across the disk surface by the actuator assembly 106, allowing the head 110 to read or write magnetic data to a particular track 113. The actuator assembly 106 may pivot on a pivot 114. The actuator assembly 106 may form part of a closed loop feedback system, known as servo control, which dynamically positions the read/write head 110 to compensate for thermal expansion of the magnetic recording media 111 as well as vibrations and other disturbances. Also involved in the servo control system is a complex computational algorithm executed by a microprocessor, digital signal processor, or analog signal processor 116 that receives data address information from a computer, converts it to a location on the media 111, and moves the read/write head 110 accordingly.

In some embodiments of hard disk drive systems, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 113 to another. Upon referencing a servo pattern, the read/write head 110 obtains head position information that enables the control circuitry 116 to subsequently realign the head 110 to correct any detected error.

Servo patterns may be contained in engineered servo sections 112 embedded within a plurality of data tracks 113 to allow frequent sampling of the servo patterns for improved disk drive performance, in some embodiments. In a typical magnetic recording media 111, embedded servo sections 112 extend substantially radially from the center of the magnetic recording media 111, like spokes from the center of a wheel. Unlike spokes however, servo sections 112 form a subtle, arc-shaped path calibrated to substantially match the range of motion of the read/write head 110.

The invention has numerous advantages. The designs disclosed herein improve both axial and tangential air flow circulation relative to the disk. The features on the edge of the disk increase turbulent air flow to cleanse the air by turbulent diffusion. This also cleanses the enclosure and other disk drive components of debris generated during fabrication and manufacturing of the disk drive. The features improve the air pumping efficiency of the disk, which is defined as air energy/disk energy. Rotating the disk at operational speeds (e.g., about 5400 to 7200 rpm) can cleanse the disk in about 10 seconds, in some embodiments. In addition, the embodiments disclosed herein operated outside of human audible frequencies to avoid acoustic noise issues. These designs are particularly well suited for disk drive applications having fewer disks, or a single disk such as depopulated drives, where generating both axial and tangential air flow are problematic for cleaning purposes. Both magnetic and optical disk drives may employ these designs.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A disk drive, comprising:
an enclosure;
a disk rotatably mounted to the enclosure and having an axis, an axial thickness and a disk rim at a disk outer perimeter thereof;
an actuator pivotally mounted to the enclosure;
a shroud mounted to the enclosure adjacent the disk and having a shroud interior surface facing the disk rim; and
at least one of the disk rim and the shroud interior surface have features formed thereon that cause both axial and circumferential air flow when the disk is rotated relative to the shroud, and the features extend for an axial distance of no more than the axial thickness of the disk.

2. A disk drive according to claim 1, wherein the features extend both axially and circumferentially relative to said at least one of the disk rim and the shroud interior surface.

3. A disk drive according to claim 1, wherein the features are slanted.

4. A disk drive according to claim 1, wherein the features are helical.

5. A disk drive according to claim 4, wherein the helical features have an axial periodicity of about 100 mm.

6. A disk drive according to claim 1, wherein the features are slits that extend into said at least one of the disk rim and the shroud interior surface.

7. A drive according to claim 6, wherein the slits have a radial dimension of about 0.15 to 0.3 mm.

8. A disk drive according to claim 1, wherein the disk rim is beveled at about 45 degrees with bevels having a radial dimension of about 0.150 mm.

9. A disk drive according to claim 1, wherein the features are formed at a circumferential pitch angle of about 2 to 10 degrees relative to said at least one of the disk rim and the shroud interior surface.

10. A disk drive according to claim 1, wherein the features extend continuously and completely around the disk rim or shroud interior surface.

11. A disk drive according to claim 1, wherein the disk rim is asymmetric.

12. A disk drive according to claim 1, wherein the disk rim is asymmetrically beveled.

13. A disk drive according to claim 1, wherein the disk rim is asymmetrically beveled with chamfers having a radial dimension of about 0.1 mm on one axial side of the disk rim, and about 0.25 mm on an opposite axial side of the disk rim.

14. A disk drive, comprising:
an enclosure;
a disk rotatably mounted to the enclosure and having an axis, an axial thickness and a disk rim at a disk outer perimeter thereof;
an actuator pivotally mounted to the enclosure;
a shroud mounted to the enclosure adjacent the disk and having a shroud interior surface facing the disk rim; and
the disk rim has features formed thereon that cause both axial and circumferential air flow when the disk is rotated relative to the shroud, and the features extend for an axial distance of no more than the axial thickness of the disk.

15. A disk drive according to claim 14, wherein the features extend both axially and circumferentially relative to the disk rim and are helical slits.

16. A disk drive according to claim 15, wherein the slits have a radial dimension of about 0.15 to 0.3 mm.

17. A disk drive according to claim 14, wherein the features are formed at a circumferential pitch angle of about 2 to 10 degrees relative to the disk rim, and the features extend continuously and completely around the disk rim.

18. A disk drive according to claim 14, wherein the disk rim is asymmetric.

19. A disk drive according to claim 14, wherein the disk rim is asymmetrically beveled.

20. A disk drive according to claim 14, wherein the disk rim is asymmetrically beveled with chamfers having a radial dimension of about 0.1 mm on one axial side of the disk rim, and about 0.25 mm on an opposite axial side of the disk rim.
